(19) United States
(12) Patent Application Publication
(10) Pub. No.: US 2004/0169635 A1
(43) Pub. Date: Sep. 2, 2004

(54) Features to enhance data entry through a small data entry unit

(76) Inventor: Benjamin Firooz Ghassabian, Great Nek, NY (US)

Correspondence Address: SOFER & HAROUN LLP., 317 MADISON AVENUE, SUITE 910, NEW YORK, NY, 10017, US

(21) Appl. No.: 10/483,528

(22) PCT Filed: Jul. 12, 2002
(86) PCT No.: PCT/US02/22385

Related U.S. Application Data
(60) Provisional application No. 60/337,425, filed on Dec. 5, 2001.
(60) Provisional application No. 60/328,002, filed on Oct. 9, 2001.
(60) Provisional application No. 60/304,845, filed on Jul. 12, 2001.
(60) Provisional application No. 60/324,581, filed on Sep. 25, 2001.

(51) Int. Cl. G09G 5/00

(52) U.S. Cl. 345/156

(57) ABSTRACT

The present invention is directed to an electronic device (1800) having an extendable section containing a microphone (1802) for inputting information by voice, where in an open position, the extendable microphone (1802) is extended towards a user's mouth. In addition, the device has a keypad (1801) and where the microphone (1802) is used in a data entry method combining voice/speech of a user and the key press. In order to select a symbol on a key, the user presses the corresponding key and simultaneously speaks the symbols.

### RELATED APPLICATIONS

This PCT application claims the benefit of priority from U.S. Provisional Patent Application No. 60/304,845, filed on Jul. 12, 2001, entitled, “Extendable Microphone”; U.S. Provisional Patent Application No. 60/324,581, filed on Sep. 25, 2001, entitled, “Method of Correction and Repeating of Symbols and Words”; U.S. Provisional Patent Application No. 60/328,002, filed on Oct. 9, 2001, entitled, “Method of Configuration of Symbols on a Keypad and, Additional Features to Enhance Data Entry Through a Keypad”; and U.S. Provisional Patent Application No. 60/337,425, filed on Dec. 5, 2001, entitled, “Features to Enhance Data Entry Through a Small Data Entry Unit”.

### SPECIFICATION

The invention described hereafter relates to method of configuration of symbols such as characters, punctuation, functions, etc. (e.g. symbols of a computer keyboard) on a small keypad having a limited number of keys, for data entry in general, and for data and/or text entry method combining voice/speech of a user and key interactions (e.g. key presses) on a keypad, in particular. This method facilitates the use of such a keypad.

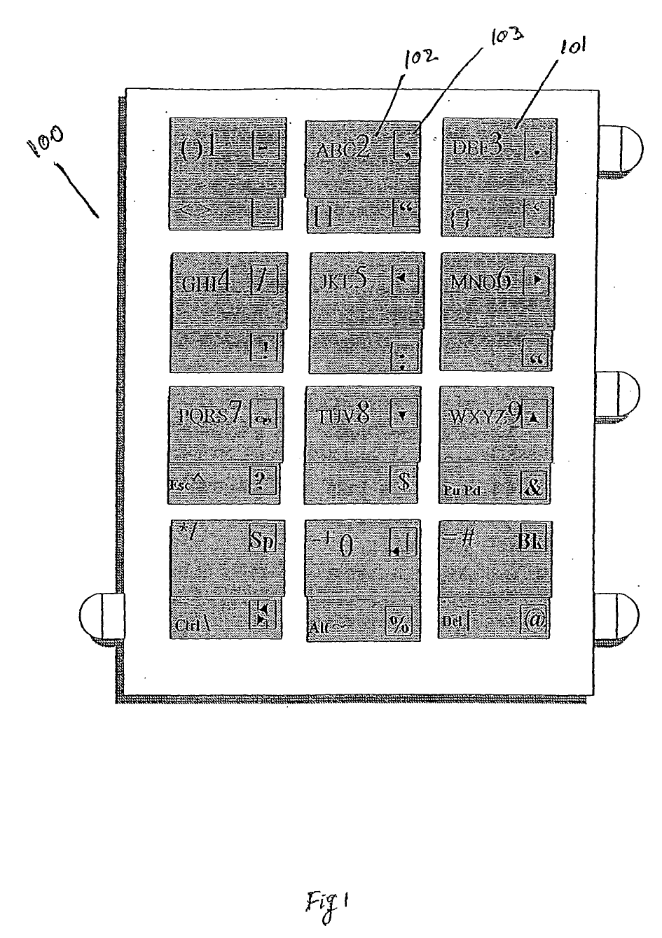

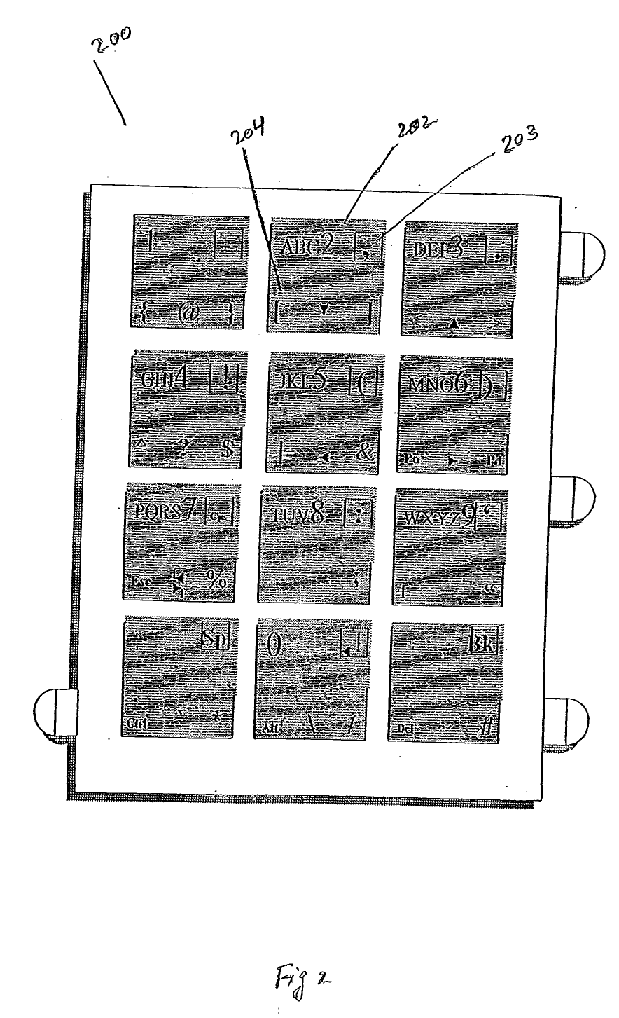

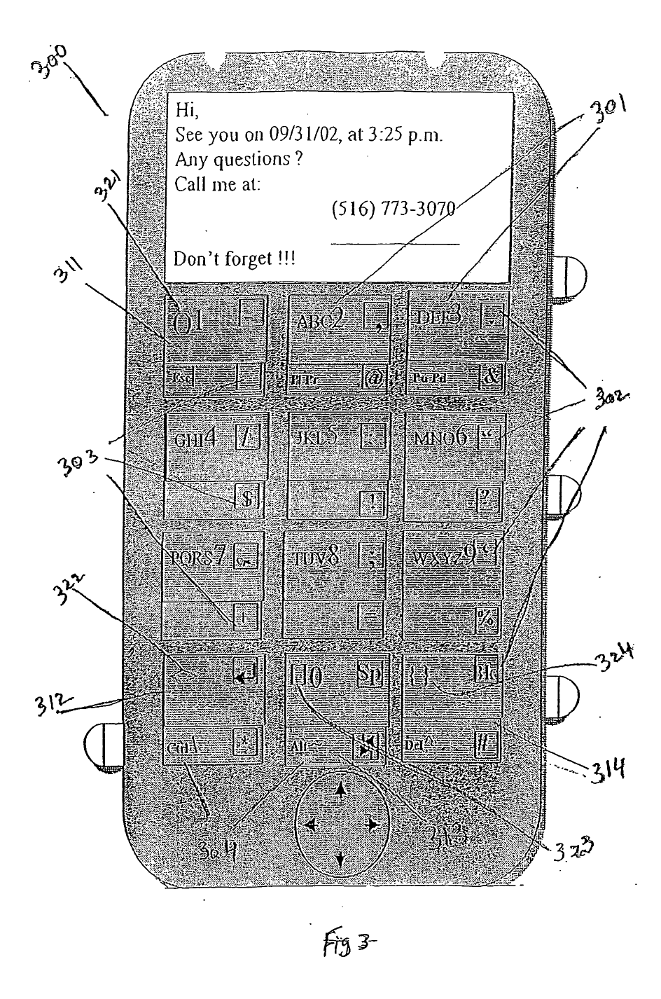

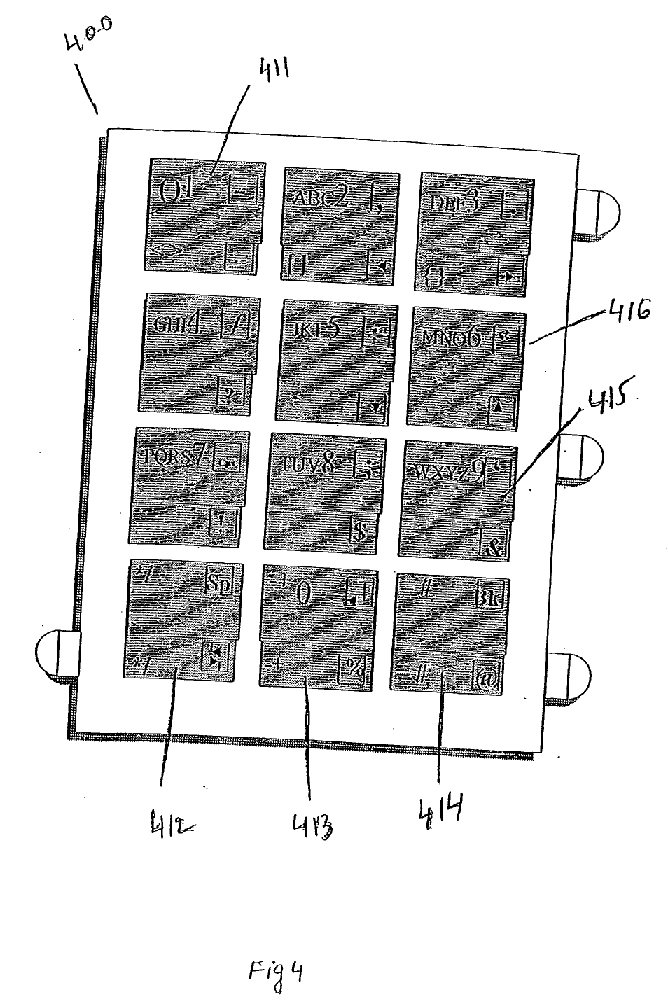

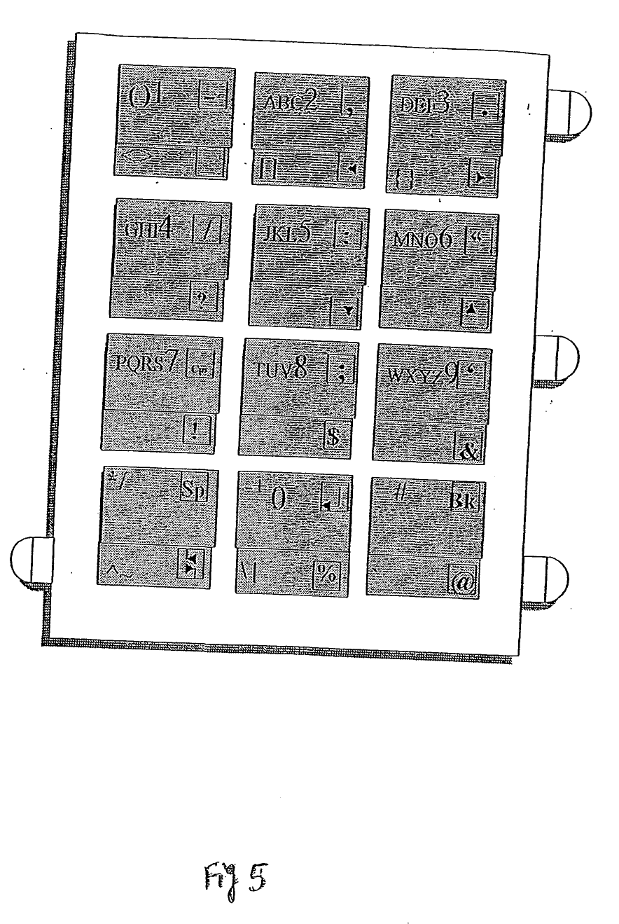

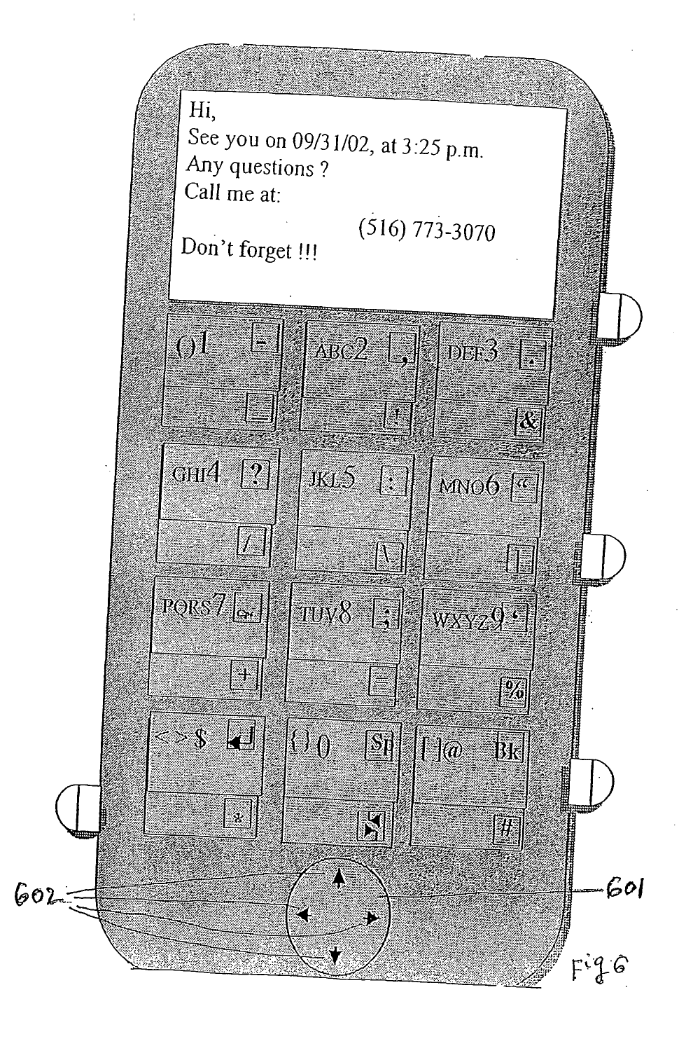

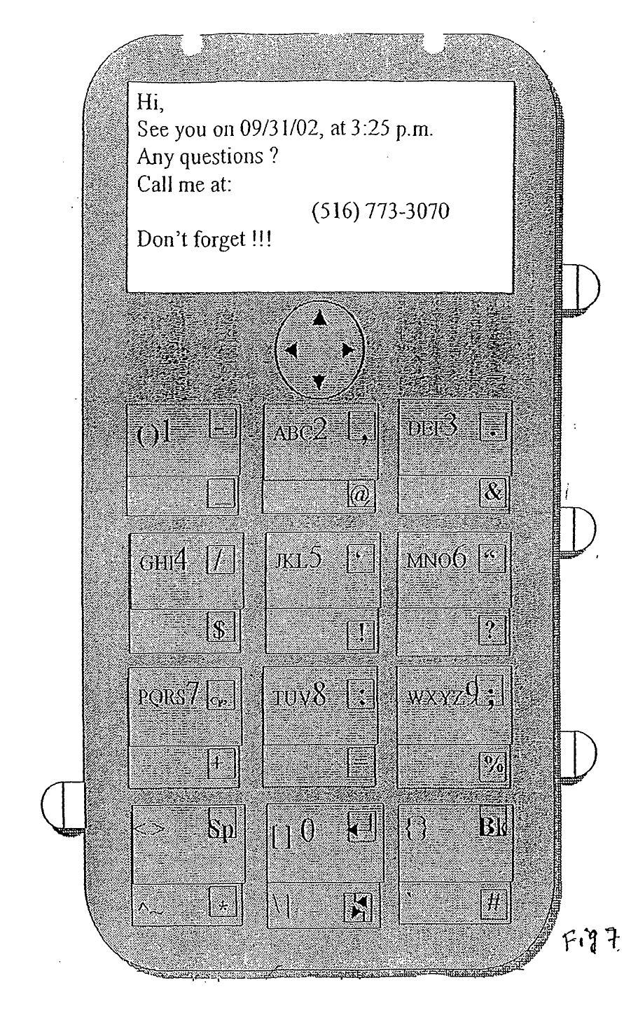

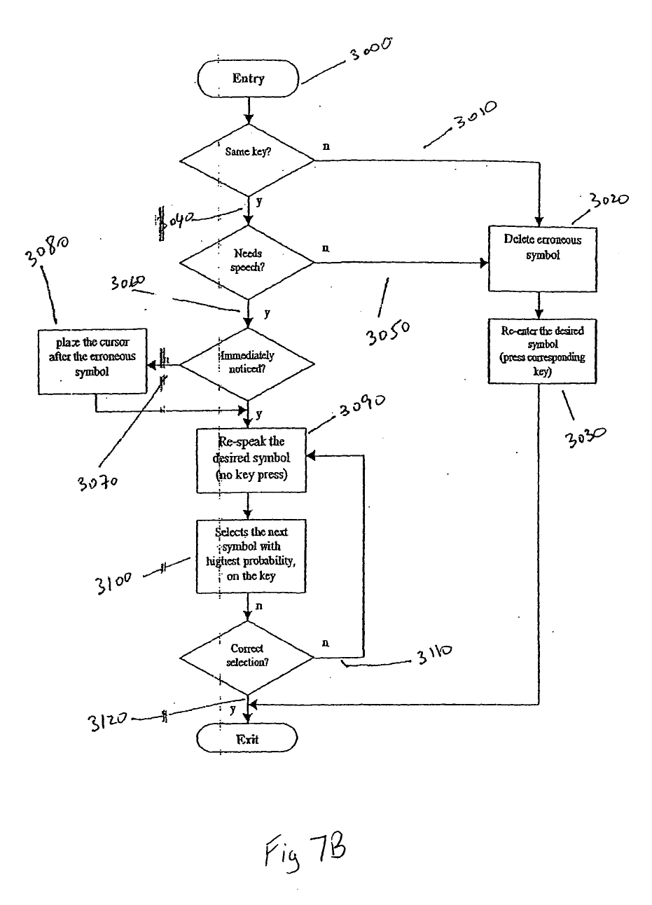

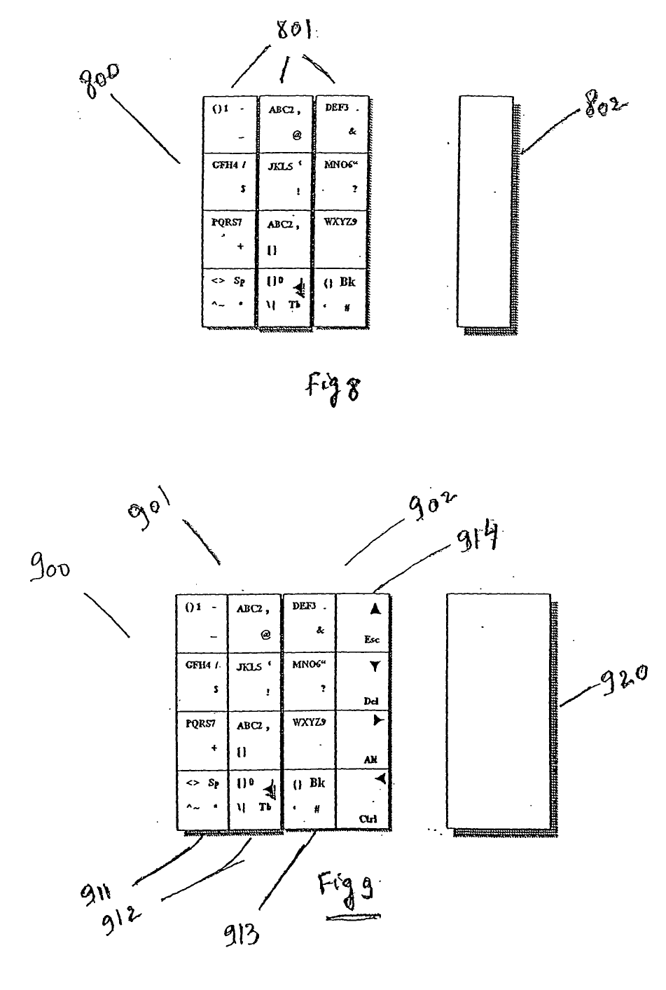

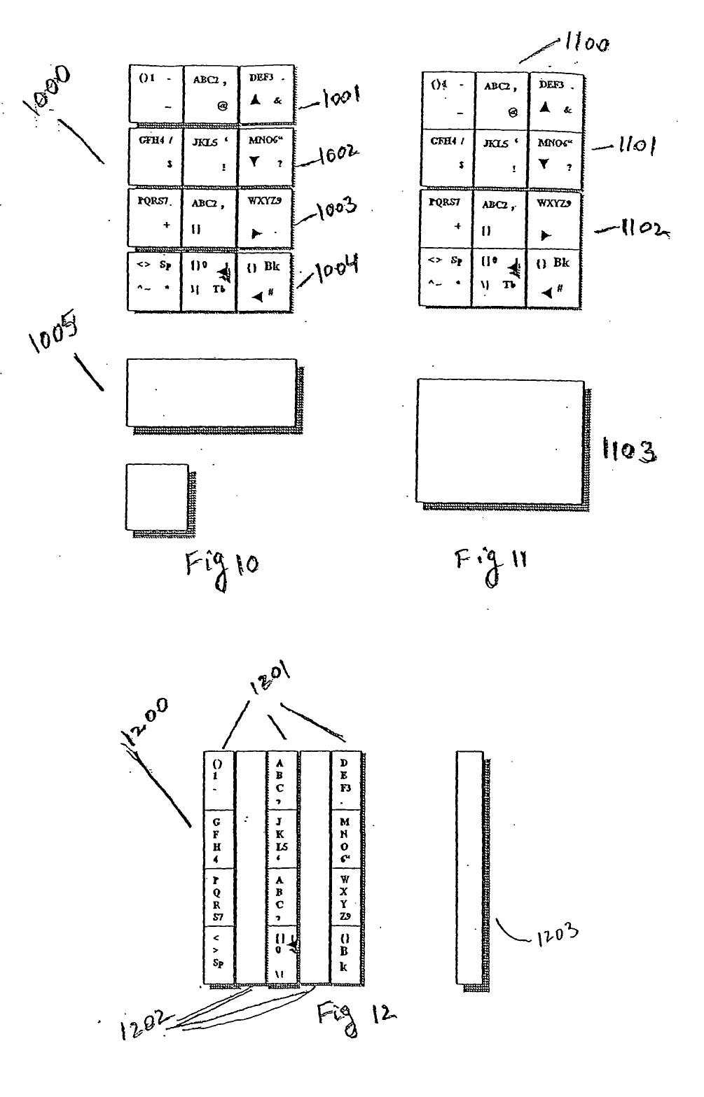

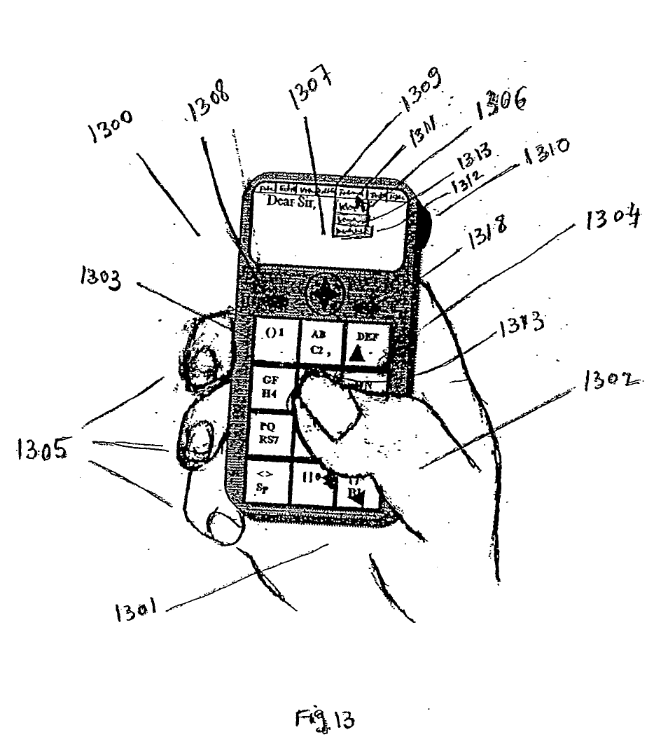

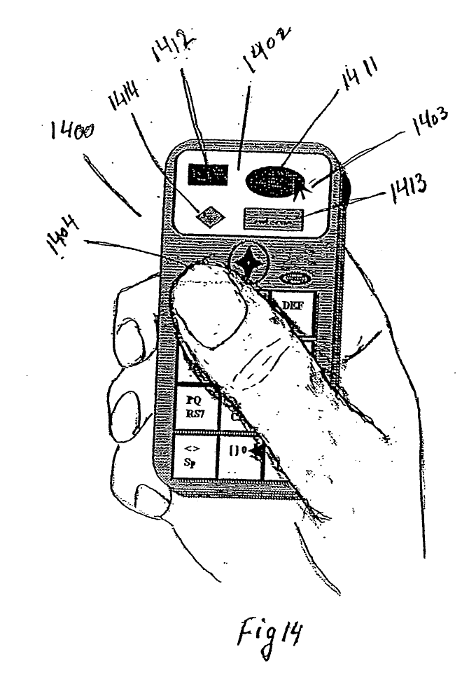

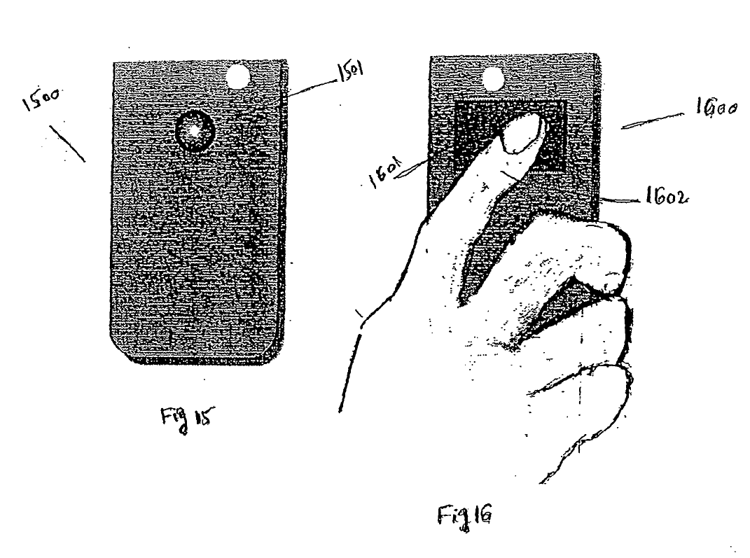

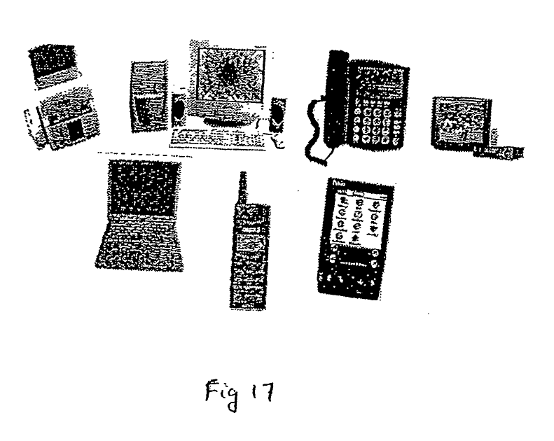

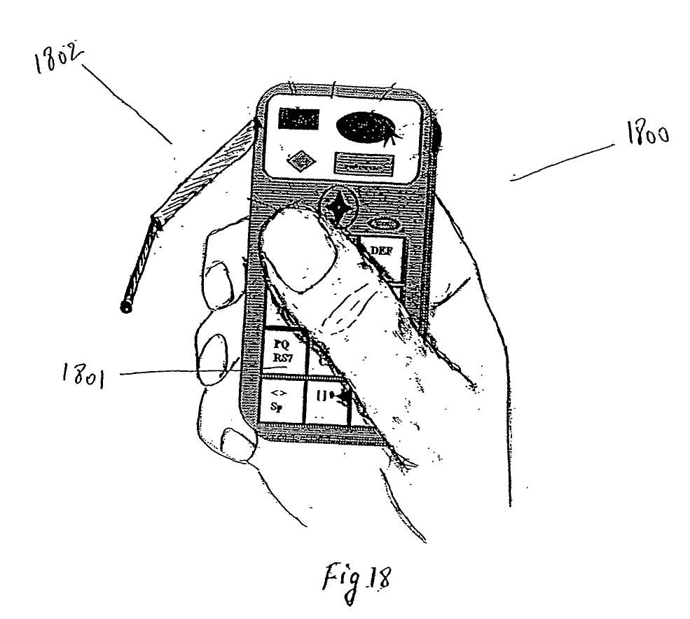

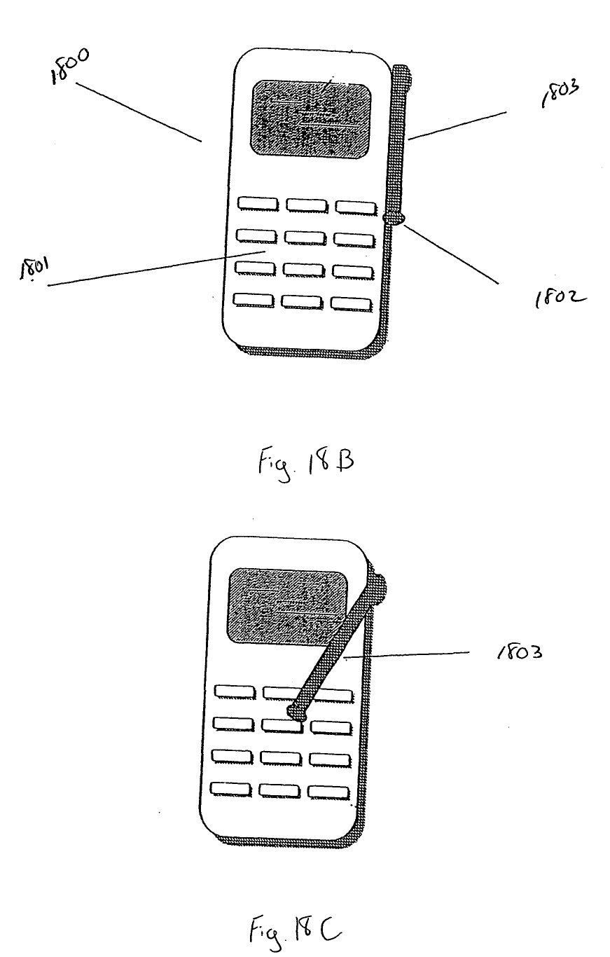

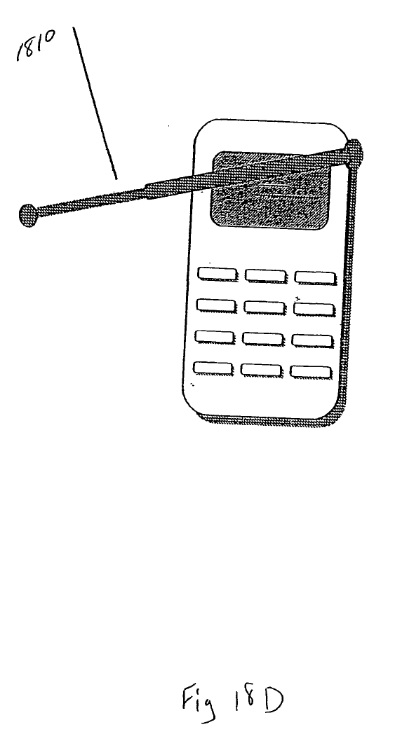

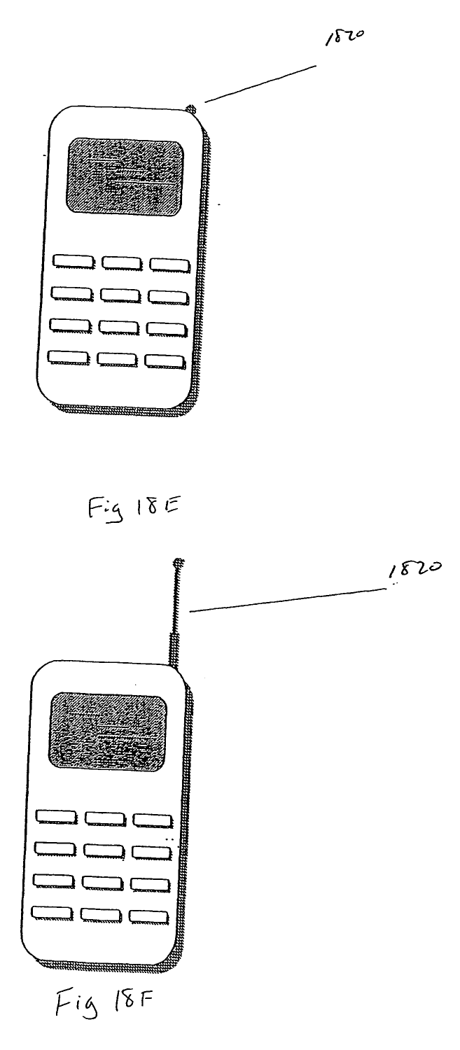

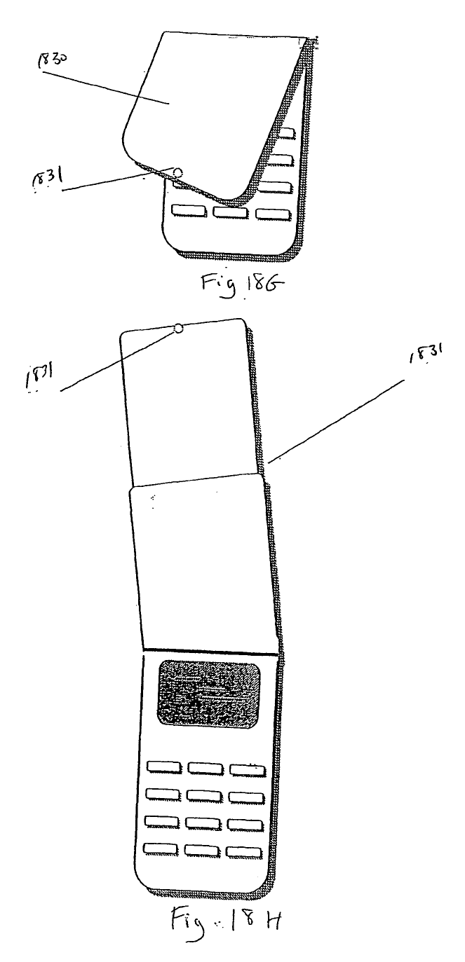

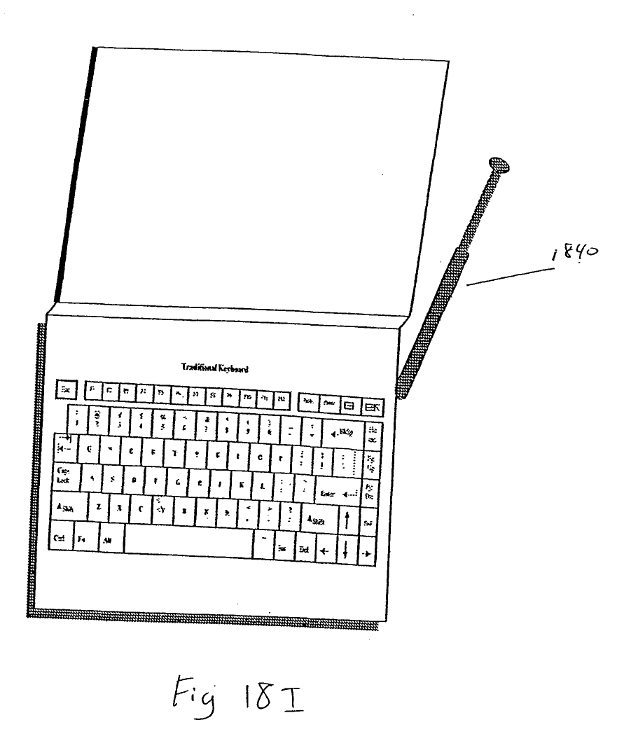

FIG. 1, shows an example of an integrated keypad 100 for a data entry method using key presses and voice/speech recognition systems. In this example, the keys of the keypad may respond to one or more type of interactions with them. Said interactions may be such as:

pressing a key with a specific finger or a portion of a finger (using a finger recognition system)

a single tap (e.g. press) on a key or a double tap (e.g. two consecutive presses with short time interval) on a key.

a slight pressure (or a touch) on a key, or a heavy pressure on a key

a short time interaction with a key (e.g. a short time pressing of a key) or a longer time pressing of a key

etc...

To each of said interactions or to any combination of them with the keys of the keypad, a group of symbols on said keypad may be assigned. For example, the symbols shown on the top side of the keys of the keypad 100, may be assigned to a single pressure on the keys of the keypad. If a user, for example presses the key 101, the symbols “DEF3.” may be selected. In the same example, the symbols configured on the bottom side of the keys of the keypad 100, may be assigned for example, to a double tap on said keys. If a user, for examples double taps on the key 101, then the symbols “{ }' ” are selected.

Same selection may also be possible with other interactions such as those described before depending on the system implemented with the keys of the keypad. For example, a slight press (or a touch) on the key 101, could select the symbols configured on the top side of said key, and a heavier pressure on the same key, could select the symbols configured on the bottom side of said key.

As described, when a user interacts with a key, a recognition system candidates the symbols on said key which are assigned to said type of interaction. For example, if a user touches or slightly presses the key 102, the system candidates the symbols, “A”, “B”, “C”, “2”, and “,”. To select one of said candidated symbols, said user may speak, for example, either said symbol or a position appellation of said symbol on said key. For this purpose a voice/speech recognition systems is used.

If the user does not speak, a predefined symbol among those candidated symbols, may be selected as default. In this example, the punctuation “,” shown in a box 103 is selected. To select one of the other candidated symbols, for example the letter “B”, the user may speak said letter.

In the same example, if the user presses heavily the key 102, then the symbols “[“, “]”, and “”“ may be candidated. As described above, if the user does not speak, a predefined symbol among those selected by said pressing action, may be selected as default. In this example, the punctuation ““” is selected. Also in this example, to select a desired symbol among the two other candidated symbols “[“, or “]”, the user may use different methods such as speaking said desired symbol, and/or speaking its position relating to the other symbols, and/or speaking its color (if each symbol has a different color), and/or any predefined appellation (e.g. a predefined voice or sound generated by a user) assigned to said symbol. For example, if the user says “left”, then the character “[“ is selected. If the user says “right”, then the character “]” is selected.

Of course, instead of using a voice/speech, a behavior of a user combined with a key interaction may select a symbol. For example, a user may press the key 102 heavily and swipe his finger towards a desired symbol.

The above-mentioned method of data entry may also be applied to a keypad having keys responding to a single type of interaction with said keys (e.g. a standard telephone keypad having [symbol] -buttons). As shown in FIG. 2, a keypad 200 having keys responding to a single interaction with said keys. When a user presses a key all of the symbols on said key are candidated by the system. For example, if the user presses the key 202, then the symbols, “A”, “B”, “C”, “2”, “,”, “[“, “ “, and “]” are canditated.

In this example, if the user does not speak, the system may select a predefined default symbol. In this example, punctuation “,” 203 is selected.

Still in the same example, to select a desired symbol among the said candidates, the user may either speak a desired symbol, or for example, speak a position appellation of said symbol, on said key or relating to other symbols on said key, or any other appellation as described before. For example, a [symbol] symbol among those configured on the top of the key (e.g. “A”, “B”, “C”, or “2”), may be selected by speaking it. In other hand, for example, one of the symbols configured on the bottom side of the key, (e.g. “[“, “ “, or “]”) may be selected by speaking its position relative, for example, to the two other symbols on the bottom side of said key, by saying for example, “left”, “middle, or “right”. For example, to select “[” 204, the user may press the key 202 and say “left”.

As mentioned, the keys the keypad of FIG. 1 may respond to at least two predefined types of interactions with them. Each type of interaction with a key of said keypad may candidate a group of said characters on said key.

As described before, during a data entry such as writing a text, different interactions with the keys (e.g. one tap, double tap) and different user behavior (e.g. speaking, not speaking) combined with said key interactions, may be required. Although the data entry method of this invention is a quick and easy data entry, a good configuration of the symbols on the keys of the keypad of this invention, may result a still easier and quicker data entry system. This method will be described hereafter.

According to one embodiment, as shown in FIG. 3, a number of symbols (e.g. symbols on a computer keyboard) are physically divided into at least two groups and arranged on a telephone keypad keys by their order of priority (e.g. frequency of use, familiarity of the user with existing arrangement of some symbols such as letters and digits on a standard telephone keypad, etc.), as follow:

First Group Assigned to a First Type of Interaction with a Keys

a) A first subgroup using voice/speech

Digits 0-9, and letters A-Z may be placed on the keys of a keypad according to standard configuration and assigned to a first type of interaction (e.g. a first level of pressure) with said keys. A desired symbol among them may be selected by interacting (e.g. said first type of interaction) with a corresponding key and naturally speaking said symbol. In FIG. 3 said symbols (e.g. 301) are configured on the top side of the keys.

Letters and digits may frequently be used during, for example, a text entry. They both, may naturally be spoken while, for example, tapping on corresponding keys. Therefor, for faster and easier data entry, they preferably may be assigned to a same type of interaction with the keys of a keypad.

b) A second subgroup not using voice/speech At least part of the other symbols (e.g. punctuation, functions, etc.) which are frequently used during a data (e.g. text) entry may be placed on the keys (one symbol per key) of the keypad and be assigned to said first type of interaction (e.g. a single tap) with said keys. As default, a desired symbol may be selected by only said interaction with corresponding key without the use of speech/voice. In FIG. 3 said symbols (e.g. 302) are configured in boxes on the top side of the keys.

Of course, said symbols may also be selected by speaking them while interacting with a corresponding key, but because speaking this kind of symbols (e.g. punctuation, functions) is not always a natural behavior, it is preferable to not to speak them.

At Least a Second Group Assigned to at Least a Second Type of Interaction with at Least One Key

At least part of the remaining symbols may be assigned to at least a second type of interaction with said keys of said keypad. They may be divided into two groups as follow:

c) A third subgroup not using voice/speech A third subgroup comprising the remaining frequently used symbols and the ones which are difficult and/or not natural to pronounce, may be placed on said keys of said keypad (one symbol per key) and assigned to a second type of interaction (e.g. double tap, heavier pressure level, two keys pressed simultaneously, a portion of a finger by which the key is touched, etc.) with said keys.

As default, a desired symbol may be selected by only said interaction with a corresponding key without the use of speech/voice. In FIG. 3 said symbols (e.g. 303) are configured in boxes on the bottom side of the keys.

Of course, said symbols may also be selected by speaking them while interacting with a corresponding key, but because speaking this kind of symbols (e.g. punctuation, functions) is not always a natural behavior, it is preferable to not to speak them.

d) At least a fourth subgroup using voice/speech

A fourth subgroup comprising at least part of remaining symbols may also be assigned to said second type of interaction with the keys of said keypad and be combined with a user's behavior such as voice. In FIG. 3 said symbols (e.g. 304) are configured on the bottom side of the keys. Said symbols may be selected by said second type of interaction with a corresponding key and use of voice/speech in different manners such as:

the symbols being selected by naturally pronouncing their appellation

the symbols being selected by naturally speaking their position relative to each other on a key or their position while using them in a text (e.g. “<”, “>” in this example, said symbols do not belong to said second type of interaction, this is only an example), by saying for example, “left, right, open, close, etc.”

the symbols which are very rarely used (they are very few) and/or are difficult to pronounce (e.g. 304). For a fast and easy data entry method, said symbols may also be selected by speaking their position on a key, or relative to each other on said key. Of course they be selected by using other speech such a pronouncing them.

e) Others

If needed, other symbols such as “F1-F12”, etc. may be provided on the keys of the keypad and assigned a type of interaction. For example, they may be assigned to said second type of interaction (with or without using speech), or be assigned to another kind of interaction such as pressing two keys simultaneously, triple tagging on corresponding key(s), using a switch to enter to another mode, etc.

More Considerations to Enhance the Keypad and the Use of it

Because Digits 0-9, and letters A-Z may be placed on the keys of a keypad according to standard configuration and be assigned to a first type of interaction (e.g. a first level of pressure, a single tap, etc.) with said keys combined with speech, some keys such as 311, 312, 313, and 314, may contain at most one symbol (e.g. digit 1 on the key 311, or digit 0 on the key 313) used in said configuration. Thus for better use of said keys, some easy and natural to pronounce symbols 321-324 may be added on said keys and be assigned to said first type of interaction for example, a user can select the character “(“ by using a first type of interaction with key 311 and saying, for example, “left”, or “open”. To select the character“)“ the user may use the same first type of interaction with said key 311 and say for example, “right” or “close”. This is a quick, and more importantly a natural speech for said symbols. Because the number of candidated symbols on said keys 311-314, assigned to said first type of interaction does not exceed the ones on the other keys, the voice recognition system may still have a similar degree of accuracy as for the other keys.

Also, some symbols may be used in both modes (interactions with the keys). Said symbols may be configured more than once on a keypad (e.g. either on a single key or on different keys) and be assigned to a first and/or to a second type of interaction with corresponding key(s).

FIG. 3, illustrates a preferred embodiment of this invention for a computer data entry system. The keys of the keypad 300 respond to two or more different interaction (such as different levels of pressures, single or double tap, etc.) on them. As shown, a number of symbols, such as alphanumerical characters, punctuations, functions, and PC command are distributed among said keys as follow:

### Mode 1

First group—Letters A-Z and digits 0-9 are the symbols which are very frequently used during a data entry such as writing a text. They may easily and most importantly, naturally, be pronounced while pressing corresponding keys. Therefor they are arranged together on the same side on the keys, belonging to a same type of interaction (e.g. a first mode) such as a single tap (e.g. single press) on a key, and are selected by speaking them.

Second group—Characters such as punctuations, and functions which are very frequently used during a data entry such as writing a text, may belong to a same type of interaction which is used for selecting said letters and digits (e.g. said first mode). This is to stay, as much as possible, with a same type of interaction with the keys while entering data. Each key may only have one of said characters of said second group. This group of symbols may be selected by only pressing a corresponding key, without using voice. For better distinction, they are shown in boxes on the top (e.g. same side as for the letters and the digits) of the keys.

### Mode 2

Other symbols of said number of symbols are shown on the bottom side of the keys of the keypad. They are assigned to a second type of interaction (e.g. double tap) with said keys.

Third group—The default symbols (e.g. those which require an interaction with a key and may not require use of voice) are shown in boxes. Said symbols comprise characters, punctuations, functions, etc., which are less currently used by users.

Fourth group—Finally the symbols which are rarely used in a data entry, and are not spelled naturally, are in this example, located at the left side on the bottom side of the keys. They may be selected by corresponding interaction (e.g. double tapping) with corresponding key and either (e.g. almost simultaneously) pronouncing them, or calling them by speaking a predefined speech or voice assigned to said symbols (e.g. “left, right”, or “blue, red” etc.).

By using a keypad having keys corresponding to different type of interaction with them (preferably two types, to not complicate the use of the keys) and having some symbols which do not require speech (e.g. defaults), when a key of said keypad is interacted, either a desired key is directly interacted (e.g. default), or the candidated symbols to be selected by a user behavior such as voice/speech are minimal. This augments the accuracy of voice recognition system.

For example, when a user slightly presses a key, the system selects the symbols on the top of said key among those symbols situated on said key. If the user simultaneously uses a voice, then the system selects those symbols requiring voice among said selected symbols. This procedure of reducing the number of candidates and requiring voice recognition technology to select one of them, is used to have a data entry with high accuracy through a keypad having a limited number of keys. The reducing procedure is made by user natural behaviors, such as pressing a key and/or speaking.

As shown in FIG. 4, the keys 411, 412, 413, and 414, have up to one symbol (shown on the top side of said keys) requiring voice interaction and assigned to a first type of interaction with said keys. On the other hand, same keys on the bottom side contain two symbols which require a second type of interaction with said keys and also requires voice interaction. Said two symbols may be used more frequently (e.g. in an arithmetic data entry or when writing a software, etc.) than the other symbols belonging to same category. In this case and to still minimize the user errors while interacting with keys (e.g. pressing), said symbols may also been assigned to said first type of interaction with said keys. The total of the candidated symbol remains low. A user may press said key as he desires and speak.

Additional arrangements may be provided on above-mentioned keypad to facilitate its use by a user. For example, “-“ and “_”,“”” and “'”, or “;” and “:” [symbol] be configured as default symbols on a same key 411, or on two neighboring keys 415, 416. Also “Sp” and “ “ (e.g. Tab), may also be considered as default symbols and been configured on the same key 412, each responding to a different type of interaction (e.g. pressing level) with said key. For example, by pressing once the key 412, the character “Sp” is selected. By double tapping the same key, the “tab” function is selected.

While interacting with a key (e.g. pressing a key once or double tagging on it), by not releasing said key, a symbol corresponding to said interaction (including speech if needed) may be selected and repeated until the key is released. For example, by double tapping on the key 415 and keeping the key pressed after the second tap and not speaking, the default symbol (e.g. “&”) assigned to said interaction is selected and repeated until the user releases said key. To enter the letter “X” and repeating it, the user may for example, press the corresponding key 415 (without releasing it) and say “X”. The letter “X” will be repeated until the user releases said key.

Also, for a more familiar look of the keypad, letters, digits, and characters such as “#” and “*”, may be placed on said keys according to a standard telephone keypad configuration.

Additional keys separately disposed from the keys of said keypad may be used to contain some of said symbols or additional symbols. In the example of FIG. 6, the cursor is navigated in different directions by at least one key separately disposed from the keys of the keypad 600. A single key 601, may be assigned to all directions 602. The user may, for example, press said key and say 37 up, down, left, or right to navigate the [symbol] in corresponding directions. The key 601, may also be a multi-directional key (e.g. similar to those used in video games, or in some cellular phones to navigate in the menu). The user may press on the top, right, bottom, or left side of the key 601, to navigate the cursor accordingly. Also a plurality of additional keys may be assigned, each to for example, to at least a symbol such as “ “.

Said additional keys may be the existing keys on an electronic device. For example, in a cellular phone, in addition to the twelve keys of a standard telephone keypad, additional function keys such as menu key, or on/of key etc., are provided at least some of those keys may be used as additional data entry keys, containing a number of symbols, while the system is, for example, in a text entry mode. This frees some spaces on the standard telephone keypad keys. The freed spaces may permit a better accuracy of voice recognition system and/or a more user friendly configuration of the symbols on the keys of the keypad.

The above-mentioned method of configuration and the examples shown before are only shown as examples. Of course many other configurations of the symbols and different assignment to different user interactions with the keys may be considered. For example, a key may not have a default symbol or on a key, there may be no symbols which are assigned to a voice/speech.

Also not all of the keys of the keypad may respond to a same kind of interaction. For example, a first key of a keypad may respond to two levels of pressure while another key of the same keypad may respond to a single or double tap on it.

FIGS. 1-7 show different configurations of the symbols on the keys of keypads.

The above-mentioned data entry system permits a full data entry such as a full text data entry through a computer keypad. By inputting, one by one, characters such as letters, punctuation marks, functions, etc, words, and sentences may be inputted.

This will have a great impact on telecommunication market permitting to enhance many applications and methods already in use. Some of them are listed hereafter. It is understood that any combination of the above-mentioned interactions may be used for inputting a desired symbol.

According to one embodiment of the invention, the user uses voice/speech to input a desired symbol such as a letter without other interaction such as pressing a key. The user may use the keys of the keypad (e.g. single press, double press, triple press, etc) to enter symbols such as punctuations without speaking them.

Correction and Repeating of Symbols

Different methods may be used to correct an erroneously entered symbol. As mentioned, to enter a symbol, a user for example, may press a corresponding key and speak said desired symbol configured on said key. It may happen that the voice/speech recognition system misinterprets the user's speech and the system selects a non-desired symbol configured on said key.

For example, if the user:

a) recognizes an erroneously entered symbol before entering a next desired symbol (e.g. the cursor is positioned after said erroneous symbol, next to it), he then may proceed a correction procedure explained hereafter;

b) recognizes an erroneously entered symbol after entering at least a next symbol, he first may navigate in the text by corresponding means such as the key 101 (FIG. 1), or 202 (FIG. 2), having navigation functions, and positions the cursor after said erroneous symbol next to it. He, then, proceeds to a correction procedure explained hereafter;

After positioning the cursor after said erroneous symbol, next to it, the user may re-speak either said desired symbol or its position appellation without re-pressing said corresponding key. If the system again selects the same deleted symbol, it will automatically reject said selection and selects a symbol among remaining symbols configured on said key, wherein either its appellation or its position appellation corresponds to next highest probability corresponding to said user's speech. If still an erroneous symbol is selected by the system, the procedure of re-speaking the desired symbol by the user and the selection of the next symbol among the remaining symbols on said key with highest probability, may continue until said desired symbol is selected by the system.

It is understood that in a data entry system using a keypad having keys responding, for example, two levels of pressure, when correcting, the recognition system may first proceed to select a symbol among those belonging to the same group of symbols belonging to the pressure level applied for selecting said erroneous symbol. If none of those symbols is accepted by the user, then the system may proceed to select a symbol among the symbols belonging to the other pressure level on said key.

FIG. 7B, shows a flowchart corresponding to an embodiment of a method of correction. If for any reason a user wants to correct an already entered symbol, he may enter this correction procedure.

Correction procedure starts at step 3000. If the replacing symbol is not situated on the same key as the to-be-replaced symbol 3010, then the user deletes the to-be-replaced symbol 3020, and enters the replacing symbol by pressing a corresponding key and if needed, with added speech 3030 and exits 3110.

If the replacing symbol is situated on the same key as the to-be-replaced symbol 3040, and the replacing symbol does not require speech 3050, then the system proceeds to steps 3020 and 3030, and acts accordingly as described before, and exits 3110.

If the replacing symbol is situated on the same key as the to-be-replaced symbol 3040, and the replacing symbol does require speech 3060, two possibilities are considered:

a) the cursor is not situated after the to-be-replaced symbol 3070. In this case the user positions the cursor after the to-be-replaced symbol, next to it 3080, and proceeds to next step 3090;

b) the cursor is situated after the to-be-replaced symbol 3070 (e.g. the user recognizes an erroneously entered symbol, immediately). In this case the user proceeds to next step 3090;

At the step 3090, the user speaks the desired symbol without pressing a key. By not pressing a key and only speaking, the system understands that a symbol belonging to a key which is situated before the cursor must be replaced by another symbol belonging to the same key. The system then, will select a symbol among the rest of the symbols (e.g. excluding the symbols already selected) on said key with highest probability corresponding to said speech 3100. If the new selected symbol is yet a non-desired symbol 3110, the system (and the user) re-enters at the step 3090. If the selected symbol is the desired one the system exits the correction procedure 3120.

Of course, instead of the above-mentioned method, a conventional methods of correcting a symbol may also be provided for example, to correct an already entered symbol, the user may simply, first delete said symbol and then re-enter a new symbol by pressing a corresponding key and if needed, with added speech.

The text entry system, may also be applied to a word level (e.g. the user speaks a word and types it by using a keypad). A same text entry procedure may combine word level entry (e.g. for words contained in a data base) and character level entry. Therefore the correction procedure described above, may also be applied for a word level data entry.

For example, to enter a word a user may speak said word and press the corresponding keys. If for any reason such as disambiguity between two words having closed pronunciation and similar key presses, the recognition system selects a non-desired word, then the user may re-speak said desired word without re-pressing said corresponding keys. The system then, will select a word among the rest of candidates words corresponding to said key presses (e.g. excluding the words already selected) with highest probability corresponding to said speech. If the new selected word is yet not the desired one, the user may re-speak said word this procedure may be repeated until either said desired word is selected by the system or there is no other candidate word in this case, the user can enter said desired word by character by character entry system such as the one explained before.

It is understood that in word level, when correcting, the cursor should be positioned after said to-be-replaced word. For this purpose and for avoiding the ambiguity with character correction mode, when modifying a whole word (word correcting level), the user may position the cursor after said to-be-replaced word wherein at least one space character separates said word and said cursor. This is because for example, if a user wants to correct the last character of an already entered word, he should locate the cursor immediately after said character. By positioning the cursor after at least one space after the word (or at the beginning of the next line, if said word is the last word of the previous line), and speaking without pressing keys, the system recognizes that the user may desire to correct the last word before the cursor. For better result, it is understood that if the to-be-replaced word contains a punctuation mark (e.g. “.” ”?“ “,“ etc.), the cursor may be replaced after an space after the punctuation mark. This is because in some cases the user may desire to modify an erroneous punctuation mark which must be situated at the end of a word. For this purpose the user may position the cursor next to said punctuation mark.

To avoid accidental corrections (e.g. the cursor is positioned somewhere in the text and someone speaks without intending a data entry), different methods may be applied. For example, a pause or non-text key may be used while a user desires for example, to rest during a text entry. Another solution is that after the cursor is positioned in a location in a text, after a laps of time (for example two seconds) no correction of the last word or character before the cursor is accepted by the system. If a user desires to correct said word or said character he may, for example, navigate said cursor (at least one move to any direction) and bring it back to said desired position. After the cursor is repositioned in the desired location, the time will be counted from the start and the user should start correcting said word or said character before said laps of time is expired.

Repeating a Symbol

To repeat a desired symbol, the user, first presses the corresponding key and if required either speaks said symbol, or he speaks the position appellation of said symbol on its corresponding key or according to other symbols on said key. The system then selects the desired symbol. The user continues to press said key without interruption. After a predefined laps of time, the system recognizes that the user indents to repeat said symbol. The system repeats said symbol until the user stops pressing said key.

It should be noted that the above described method of correction and repeating of key symbol can be used in conjunction with any method of entry including but not limited to single/double tap, pressure sensitive keys, keys pressed simultaneously, keys pressed on only a potion thereof etc.

Telephone Directory

To make a phone call, instead of dialing a number, a user may enter a to-be-called destination by any information such as name (e.g. person, company, etc.) and if necessary enter more information such as the said to-be-called party address, etc. A central directory, may automatically direct said call to said destination. If there are more than one telephone lines assigned to a said destination (e.g. party), or there are more than one choice for said desired information entered by the user, a corresponding selection list (e.g. telephone numbers, or any other predefined assignments assigned to said telephone lines) may be transmitted to the caller's phone and displayed for example, on the display unit of his phone. Then the user may select a desired choice and make the phone call.

The above-mentioned method of calling (e.g. dialing), may permit to eliminate the need of calling a party (e.g., a person) by his/her telephone number. Therefor may eliminate (or at list reduces) the need of remembering phone numbers, carrying telephone books, or using an operator's aid.

Interactive Directories Using Voice/Speech

Voice directories are more and more used by companies, institutions, etc. This method of interaction with another party is a very time consuming and frustrating procedure for the users. Many people, by hearing a voice directory on the other side of the phone, disconnect the communication. Even when a person tries to interact with said system, it frequently happens that after spending plenty of time, the caller does not succeed to access a desired service or person. The main reason for this ambiguity is that when listening to a voice directory indication, many times a user must wait until all the options are announced. He (the user), many times does not remember all choices which were announced. He must re-listen to those choices.

Also many times the voice directory demands a data to be entered by a user. This data entry is limited in variation because of either the limited number of keys of a telephone keypad or the complexity of entering symbols through it.

The above-mentioned data entry method permits a fast visual interaction with a directory. The called party may transmit a visual interactive directory to the caller and the caller may see all choices almost instantly, and respond or ask questions using his telephone keypad (comprising the above-mentioned data entry system) easily and quickly.

Voice Mails

Voice mails may also be replaced by text mails. This method is already in use. The advantage of the method of data entry described above is evident when a user has to answer or to write a massage to another party. The data entry method of the invention is also dramatically enhances the use of massaging systems through mobile electronic devices such as cellular phones. One of the most known use is in the SMS.

The number of electronic devices using a telephone-type keypad is immense. The data entry method of this invention permits a dramatically enhanced data entry through the keypads of said devices. Of course this method is not limited to a telephone-type keypad. It may be used for any keypad wherein at least a key of said keypad contains more than one symbol.

Multi-sectioned Keypad

The size of a keypad using the above-mentioned data entry method, may still be minimized by using a keypad having multiple sections. Said keypad may be minimal in size (e.g. as large as the largest section, for example as large as of the size of an adult user's fingertip or the size of a small keypad key) in a closed position, and maximized as desired when the keypad is in open position (depending on the number of sections used and/or opened).

Theoretically, in closed position, the keypad may even have the size of a key of said keypad.

FIG. 8 shows one embodiment of said keypad 800 containing at least three sections 801, wherein each of said sections contains one column of the keys of a telephone keypad. When said keypad is in open position, a telephone-type keypad 800 is provided. In closed position 802 said keypad may have the width of one of said sections.

Another embodiment of said keypad is shown in FIG. 9. Said keypad 900 contains at least two sections 901-902 wherein a first section 901 contains two columns 911-912 of the keys of a telephone-type keypad, and a second section 902 of said keypad contains at least the third column 913 of said telephone-type keypad. When said keypad is in open position, a telephone-type keypad is provided Said keypad, may also have an additional column 914 of keys arranged on said second section. In closed position 920 said keypad may have the width of one of said sections.

As shown in FIG. 10, another embodiment of said keypad 1000 contains at least four sections 1001-1004 wherein each of said sections contains one row of the keys of a telephone keypad. When said keypad is in open position, a telephone-type keypad is provided. In closed position 1005 the length of said keypad may the size of the width of one row of the keys of said keypad.

FIG. 11 shows another embodiment of said keypad 1100 containing at least two sections 1101-1102 wherein a first section contains two rows of the keys of a telephone-type keypad, and a second section of said keypad contains the other two rows of said telephone-type keypad. When said keypad is in open position, a telephone-type keypad is provided. In closed position 1103, the length of the keypad may be as the size of the width of one row of the keys of said keypad.

The above-mentioned multi-sectioned keypad has already been described in patent applications already filed by the inventor.

By using the above-mentioned data entry method through a multi-sectioned keypad as described, a miniaturized easy to use full data entry keypad may be provided. Such keypad may be used in many device, specially those having a limited size.

Of course, the above-mentioned symbol configuration may be used on said multi-sectioned keypad.

FIG. 12 shows another embodiment of a multi-sectioned keypad 1200. The distance between the sections having keys 1201 may be increased by any means. For example, empty (e.g. not containing keys) sections 1202, may be provided between the sections containing keys. This will permit more enlarged the distance between the sections when said keypad is in open position. In other hand, it also permits to have a still thinner keypad in closed position 1203.

A Data Entry Device Having Integrated Keypad and Mouse or Point and Click Device

To enhance the data entry method through a keypad in general and through the keypad of this invention in particular, a point and click system, hereinafter a mouse, can be integrated in the back side of an electronic device having a keypad for data entry in its front side.

FIG. 13, shows an electronic device such a cellular phone 1300 wherein a user holds in palm of his hand 1301. Said user may use only one hand to hold said device 1300 in his hand and in the same time manipulate its keypad 1303 located in front, and a mouse or point and click device (not shown) located on the backside of said device. The thumb 1302 of said user may use the keypad 1303, while his index finger 1304 may manipulate said mouse (in the back). Three other fingers 1305 may help holding the device in the user's hand.

The mouse or point and click device integrated in the back of said device may have similar functionality to that of a computer mouse. Also several keys (e.g. two keys) of either the telephone-type keypad or among the additional keys of said device may be assigned to the mouse click functions for example, keys 1308 and 1318 may function with the integrated mouse of said device 1300 and have the similar functionality of the keys of a computer mouse. Said keys may have the same functionality as the keys of a computer mouse. For example, by manipulating the mouse, the user may navigate a Normal Select (pointer) indicator 1306 on the screen 1307 of said device and position it on a desired menu 1311. As for a computer mouse, said user then, for example, may tap (click) or double tap (double click) on a predefined key 1308 of said keypad (which is assigned to the mouse) to for example, select or open said desired menu 131 which is pointed by said Normal Select (pointer) indicator 1306.

Because the display of mobile devices such as cellular phones has a small size, a rotating button 1310 may be provided in said device to permit to a user to, for example rotate the menu lists. For example, after a desired menu 1311 appears on the screen 1307, a user may use the mouse to bring the Normal Select (pointer) indicator on said desired menu and select it by using a predefined key such as one of the keys 1313 of the telephone-type keypad 1303 or one of the additional keys 1308 on said device, etc.

As for a computer, then the user may press said key to open the related menu bar 1312. To select a function 1313 of said menu bar1312, the user may maintain said key pressed and after bringing the Normal Select (pointer) indicator 1306 on said function, by releasing said key, said function may be selected.

Other functionalities similar to those of a computer may be provided by using said keypad and said mouse.

Also, instead of using said keys assigned to a mouse, a user may use a predefined voice/speech or other predefined behavior(s) to replace the functions of said keys. For example, after positioning the Normal Select (pointer) indicator 1306 on an icon, instead of pressing a key, the user may say “select” or “open” to select or open the application represented by said icon.

FIG. 14, shows an electronic device such as a mobile phone 1400. A plurality of different icons 1411-1414 representing different applications, are displayed on the screen 1402 of said device. To select and/or open one of the applications, as for computers, by using a mouse, a user may bring the a Normal Select (pointer) indicator 1403, on a desired icon 1411. Then said user may select said icon by for example pressing once, a predefined key 1404 of said keypad. To open the application represented by said icon, the user, for example, may double tap on a predefined key 1404 of said keypad.

The mouse integrated in the backside of an electronic device may be of any type. For example, FIG. 15 shows the backside of an electronic device 1500 such as the ones shown in FIGS. 13-14. The mouse 1501, is similar to a conventional computer mouse. It may be manipulated, as described, with a user's finger. It may also be manipulated like a conventional computer mouse, by laying the device on a surface such as a desk and swiping said mouse on said surface.

FIG. 16, shows another conventional type of mouse (a sensitive pad) integrated on the backside of an electronic device 1500 such as the ones shown in FIGS. 13-14. The mouse 1601, is similar to a conventional computer mouse. It may be manipulated, as described, with a user's finger in this example, preferably as described before, while holding the device in the palm of his hand, the user uses his index finger 1602 to use (e.g. to manipulate) said mouse. Accordingly to this position, the user uses his thumb (not shown) to manipulate the keys of a keypad (not shown) which is located in the front side (e.g. other side) of said device.

Mobile devices should preferably, be manipulated by only one hand. This is because while the users are in motion (e.g. being in a bus or in a train) the users may use the other hand for other purposes such as holding a bar while standing in a train or using one hand to hold a newspaper or a briefcase).

By implementing the mouse in the back of a device such as a mobile phone, the user may manipulate said device and to enter data with one hand. He can use simultaneously, both, the keypad and the mouse of said device.

Of course, if he desires, said user can use his both hands to manipulate said device and its mouse.

Another method of using said device is to dispose it on a surface such as on a desk and slide said device on said surface in a same manner as a regular computer mouse and enter the data using said keypad.

It is understood that the any type of mouse including the ones described before, may be integrated in any part of a mobile device. For example, a mouse may be located in the front side of said device. Also said mouse may be located on a side of said device and being manipulated simultaneously with the keypad by fingers explained before.

It should be noted that a mouse has been used through out this discussion, however any point and click data entry device such as stylus computer integrated in an electronic device and combined with a telephone-type keypad is within the contemplation of the present invention.

External Integrated Data Entry Unit

Also, an external integrated data entry unit comprising a keypad and mouse may be provided and used in electronic devices requiring data entry means such as keyboard (or keypad) and/or mouse. There may be provided an integrated data entry unit having the keys of a keypad (e.g. a telephone-type keypad) in front of said unit and a mouse being integrated within the back of said unit. Said data entry unit may be connected to a desired device such as a computer, a PDA, a camera, a TV, a fax machine, etc.

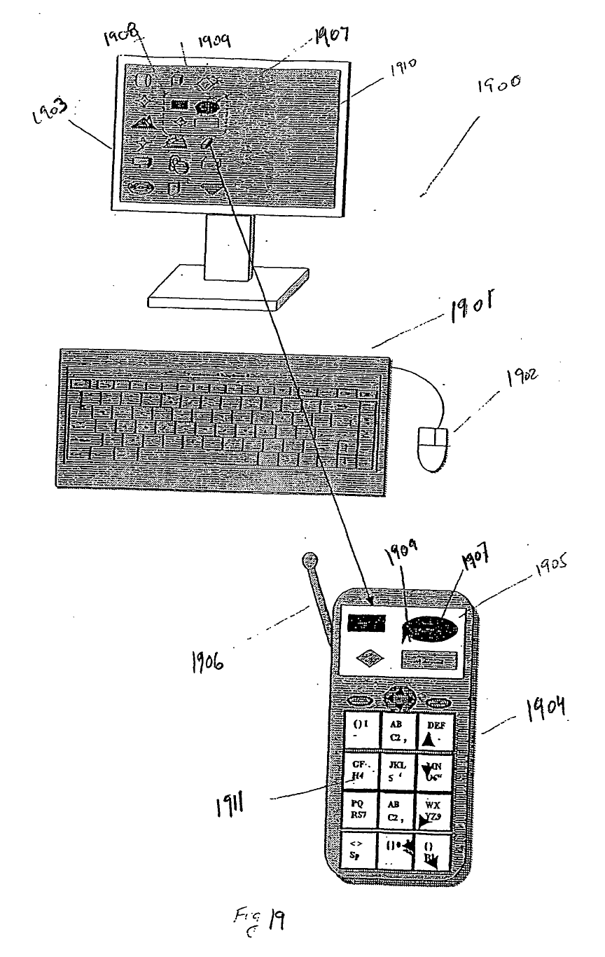

FIGS. 19 shows a computer 1900 comprising a keyboard 1901, a mouse 1902, a monitor 1903 and other computer accessories (not shown). In some circumstances (e.g. when a user does not desire to sit down on a desk chair in front of a monitor and he prefers, for example, to lie down on his bed while interacting with said computer) instead of a large keyboard and/or corresponding mouse a user may utilize a small external integrated data entry unit. There may be provided an external data entry unit 1904 containing features such as keypad keys 1911 positioned on the front side of said data entry unit; a microphone which may be an extendable microphone 1906, a mouse (not shown) integrated within the back side of said data entry unit (described before). Said data entry unit may be (wirelessly or by wires) connected to said electronic device (e.g. said computer 1900). An integrated data entry system such as the one described before (e.g. using voice recognition systems combined with interaction of keys by a user) may be integrated either within the said electronic device (e.g. said computer 1900) or within said data entry unit 1904. Also a microphone may be integrated within said electronic device (e.g. computer). Said integrated data entry system may use one or both microphones located on said data entry unit or within said electronic device.(e.g. computer).

For a better view of while interacting, specially when interacting from far with an electronic device such as said computer 1900, a display unit 1905 may be integrated within said a entry unit such as said integrated data entry unit 1904 of this invention. When interacting from far with a monitor 1903 of said electronic device 1900, a user may have a general view of the display 1910 of said monitor 1903. A closed area 1908 around the arrow 1909 or another area selected by using the mouse on the display 1910 of said monitor 1903 may simultaneously be shown on said display 1905 of said data entry unit 1904. The size of said area 1908 may be defined by manufacturer or by the user. Preferably the size of said area 1908 may be closed to the size of the display 1905 of said data entry unit 1904. This may permit a closed and/or if desired a real size view of the interacting area 1908 to the user (e.g. by seeing said area on the data entry screen 1905). While having a general view of the display 1910 of the monitor 1903, a user may have a particular closed view of the interacting area 1908 which is simultaneously shown on the display 1905 of said data entry unit 1904. For example a user may use the keypad mouse (not shown, in the back of the keypad) to navigate the arrow 1909 on the computer display 1910. Simultaneously said arrow 1909 and the area 1908 around said arrow 1909 on said computer display 1910 may be shown on the keypad display 1905.

For an interaction such as opening a file, a user may for example, navigate an arrow 1909 on a the screen 1910 of said computer an position it on a desired file 1907. Said navigated areas 1908 and said file 1907 may be seen on said data entry screen 1905. By having the display 1905 of said data entry unit 1904 closed to his eyes, a user can clearly see his interactions on the display 1905 of said data entry unit 1904 while having a general view on a large display 1910 of said electronic device 1900 (e.g. computer).

It is understood that said interaction area 1908 may be defined and vary according to different needs or definitions. For example, said interacting area may be the area around an arrow 1909 wherein said arrow is in the center of said area or said area is the area at the right, left, top, bottom, etc. of said arrow or any area on the screen of said monitor, regardless of the location of said arrow on the display of said monitor).

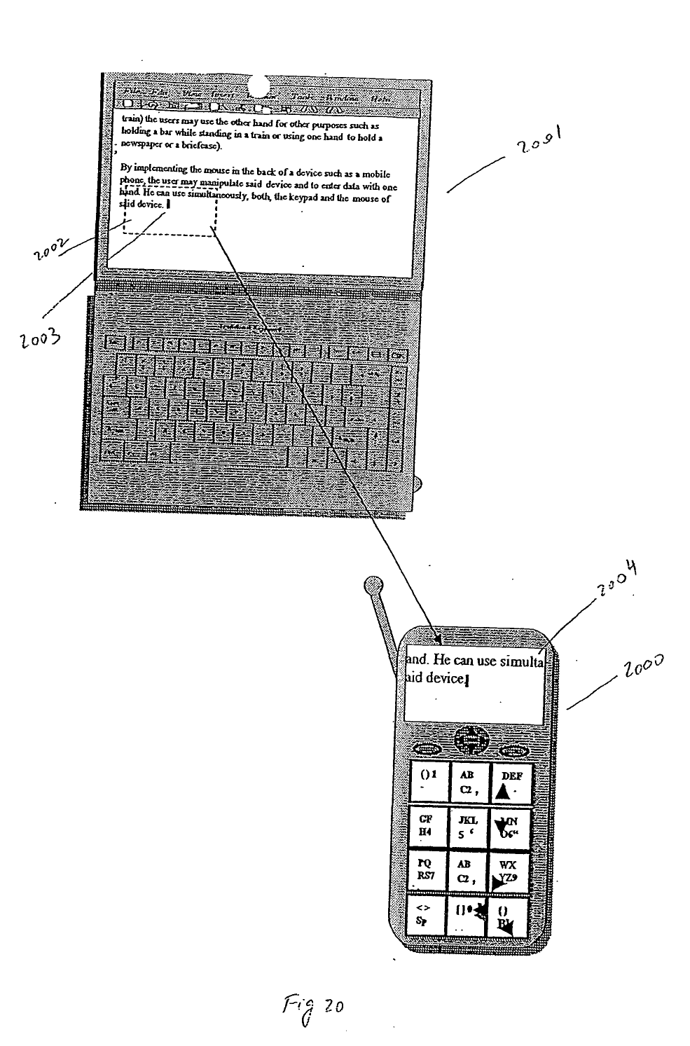

FIG. 20 shows a data entry unit 2000 such as the one described before being connected to a computer 2001. During a data entry such as a text entry, the area 2002 around the interacting point 2003 (e.g. cursor) is simultaneously shown on the keypad display 2004.

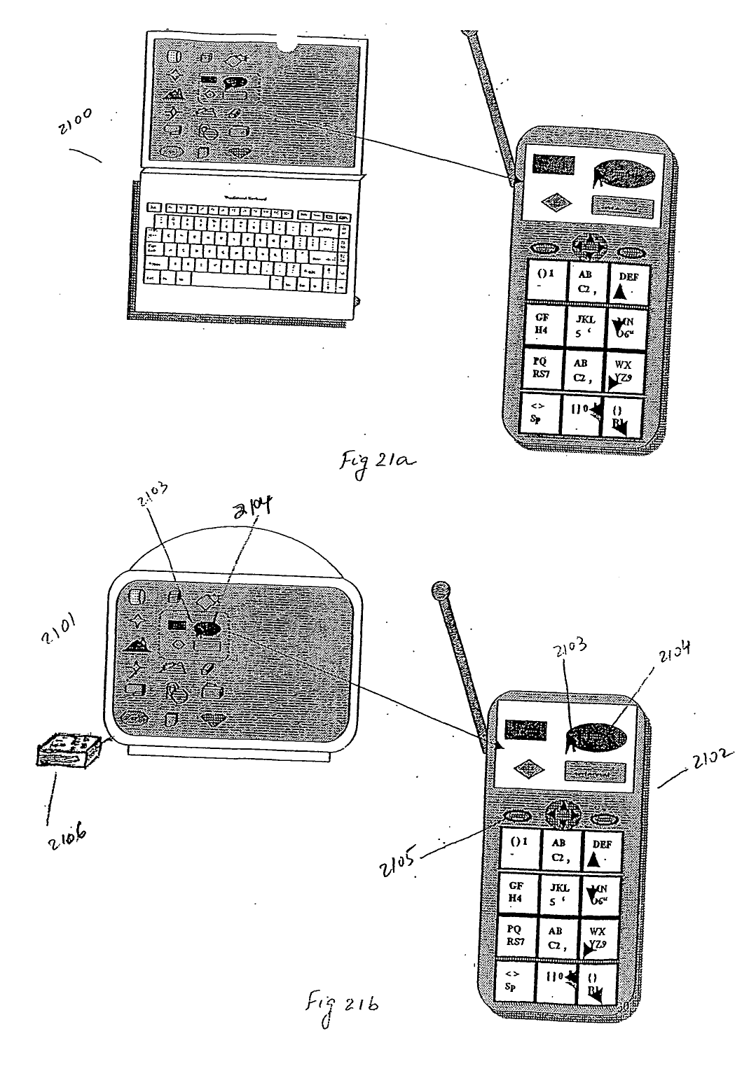

FIGS. 21a-21b show an example of different electronic devices which may use the above described data entry unit. FIG. 21a shows a computer 2100 and FIG. 21b shows a TV 2101. The data entry unit 2102 of said TV 2101 may also operate as a remote control of said TV 2101. For example, by using the mouse (not shown) situated in the back side of said data entry unit 2102, a user may locate a selecting arrow 2103 on the icon 2104 representing a movie or a channel and opening it by double tapping (double clicking) on a key 2105 of said data entry unit. Of course said data entry unit 2102 of said TV may also be used for data entry such as internet through TVs or sending massages through TVs, cable TVs, etc. In this case the integrated data entry system of this invention may be integrated within for example, the TV's modem 2106.

Extendable Microphone

An extendable and/or rotatable microphone may be integrated in electronic devices such as cellular phones. Said microphone may be a rigid microphone being extended towards a user's mouth.

With the advancement of the technology, new input systems and devices are coming to the market to permit easy interacting with instruments. Many of those input systems use voice/speech recognition system wherein a user speaks the data or commands to be input. Because it is a natural way to input data, voice recognition system is becoming very popular. Computers, telephones, toys, and many other instruments are equipped with this different kinds of data entry system using voice recognition systems.

Although this is a good method of input, it has an important shortcoming. It is not a discrete method of input. A user, usually, does not want others to hear what he speaks, and in the other hand people do not like other people's loud speaking.

To overcome (or at least reduce) significantly this problem, the user must speak quietly. To not cause misinterpretation of user's voice/speech by a voice recognition system, the microphone must be closed to user's mouth.

It is the subject of this invention to provide instruments using a user's voice as data, with a microphone extending from said instruments towards the user's mouth.

There are many advantages using such a microphone. One advantage of such a microphone is that by extending said microphone towards said user's mouth and speaking closed into it the voice/speech recognition system may better distinguish and recognize said voice/speech. Another advantage is that by positioning said microphone close to user's mouth (e.g. next to the mouth), a user may speak silently (e.g. whisper) into it. This permits an almost silent and a discrete data entry. Still, another advantage of said microphone is that because of being integrated in corresponding electronic device, in order to keep said microphone in a desired position (e.g. close to a user's mouth), a user may not have to hold said microphone by his hand(s). Also, said user does not have to carry said microphone separately from said electronic device.

By combining the features such as the enhanced keypad of the invention, the mouse, the extendable microphone and the data entry method in a manner such as the manners explained before, either in an electronic device or as an external unit to be connected to an electronic device, a completely enhanced data entry system may be provided. A user, may for example, by only using one hand, hold an electronic device such as a data entry device (e.g. mobile phone, PDA, et.), use all of the features such as the enhanced keypad, integrated mouse, and the extendable microphone, etc., and in the same time by using his natural habitudes (e.g. pressing keys of the keypad and in needed, speaking) provide a quick, easy, and specially natural data entry.

One of the most important applications of the extendable microphone is when the data entry systems of mobile communication devices combine use of is keypad and voice/speech recognition system. In this method a user interacts with a key (for example by pushing it), and in the same time he may speak for example, a symbol on said key. In order to press a key containing a desired symbol, the user may need to see the keypad. He also may need to see the data on a display of the device. In the other hand, the user may prefer to speak said symbols quietly. The extendable microphone permits to position the mobile phone far from eyes, enough to see that keypad, and in the same time to have the microphone closed to the mouth, permitting to speak quietly.

As they many people are used to, they may hold their mobile phone in one hand, while pressing the keys of the keypad with a thumb of the same hand. The second hand may be used to either hold said hand around the microphone to reduce the outside noise, or to keep the microphone in an optimal relationship with the mouth.

If the microphone of an instrument is wireless, or the member connecting it with the instrument is made from non-rigid materials, the user may hold the microphone in a manner to position it at the palm side of his hand, between two fingers. Then by positioning the palm o said hand around the mouth he can significantly reduce the outside noise while speaking.

It is understood that the user interface containing the data entry unit and the display, of an electronic device using a user's voice to input data, may be of any kind. For example, instead of a keypad it may contain a touch sensitive pad, or it may be equipped only with a voice recognition system without the need of a keypad.

FIG. 18, shows according to one embodiment of the invention, an electronic device 1800 such as a cellular phone or a PDA. As shown, the keypad 1801 is located in the front side of said device 1800. A mouse (not shown) is located in the backside of said device 1800, An extendable microphone 1802 is also integrated within said device. Said microphone may be extended and positioned in a desired position (e.g. next to the user's mouth) by a user. Said device may also contain a data entry method as described before. By using only one hand, a user may proceed to a quick and easy data entry with a very high accuracy. Positioning said microphone next to user's mouth, permits a better recognition of the voice/speech of the user by the system. Said user, may also speak silently (e.g. whisper) into said microphone. This permits an almost silent data entry.

In alternative embodiments of the present invention FIGS. 18b to 18c, show a mobile phone 1800 having a keypad 1801 and a display unit. The mobile phone is equipped with a pivoting section 1803 with a microphone 1802 installed at its end. By extending the microphone towards his mouth, the user may speak quietly into the phone and in the same time being capable to see the display and keypad 1801 of his phone and eventually use them simultaneously while speaking to microphone 1802.

FIG. 18d, shows a rotating extendable microphone 1810 to permit a user to position the instrument at a convenient relationship to him, and in the same time by rotating and extending the microphone accordingly, to bring microphone 1810 close to his mouth or to a desired location. It must be noted that the member connecting the microphone to the instrument may have at least two sections, being extended/retracted according to each other and to the instrument. They may have folding, sliding, telescopically and other movement for extending or retracting.

FIGS. 18e and 18f, shows an integrated rotating microphone 1820 being telescopically extendable. In this embodiment, the extendable section comprising microphone 1820 may be located in the instrument. When desired, a user may pull this section out and extend it towards his mouth. Microphone 1820 may also be used, when it not pulled out.

According to another embodiment of the invention as shown in FIGS. 18g and 18h, the extending member 1830 containing amicrophone 1831, may be a section of a multi-sectioned device. This section may be used as the cover of said device. The section comprising the microphone 183 may itself been multi-sectioned to be extendable and/or adjustable as desired.

According to embodiment shown in FIG. 18i, an extendable microphone 1840 as described before, may be installed in a computer or similar devices.

Also, according to another embodiment of the invention, a microphone of an instrument may be attached to a user's ring, or itself being shaped like a ring, and be worn by said user. This microphone may be connected to said instrument, either wirelessly or by wire. When in use,.the user approaches his hand to his mouth and speaks.

It is understood that instruments shown in the drawings are shown as example. The extendable microphone may be installed in any instrument. It may also be installed at any location on extending section.

In communication devices, the extending section comprising the microphone may be used as the antenna of said instruments. In this case the antennas may be manufactured as sections described, and contain integrated microphones.

It must be noted that in addition to at least an extendable microphone, an instrument may comprise at least one additional regular microphone, wherein said microphones may be used separately or simultaneously with said extendable microphone.

It must be noted that the extendable member comprising the microphone may be manufactured with rigid materials to permit positioning the microphone in a desired position without the need of keeping it by hand. For better manipulation, the section comprising the microphone may also be manufactured by semi rigid or soft materials.

It must be noted that any extending/retracting methods such as unfolding/folding methods may be used.

As described before, the integrated keypad and/or the mouse and/or the extendable microphone of this invention may also be integrated within a variety of electronic devices such as a PDA, a remote control of a TV, and a large variety of other electronic devices. For example, by using said integrated keypad and mouse within remote control of a TV, a user may point on an icon, shown on the TV screen relating to a movie and select said movie by using a predefined key of said remote control.

Also, as described, said integrated keypad and/or mouse and/or extendable microphone may be manufactured as a separated device and to be connected to said electronic devices.

Of course said keypad, alone or integrated with said mouse and/ or said extendable microphone, may be combined with a data and text entry method such as the data entry method of this invention.

FIG. 17 shows some of the electronic devices which may use the enhanced keypad, the enhanced mouse, the extendable microphone, and the data entry method of this invention.

An electronic device may contain at least one or more of the features of this invention. It may, for example, contain all of the features of the invention as described.

Data Entry Through a Land Line Phone

The data entry method described before, may also be used in land-lined phones and their corresponding networks. As known, each key of a telephone keypad generates a predefined tone which is transmitted through the land line networks. There are twelve predefined tones assigned to twelve keys of telephone keypads. By using, a land line telephone and its keypad, for the purpose of a data entry such as entering text, there may be the need of additional tones to be generated. To each symbol, there may be assigned a different tone so that the network will recognize a symbol according to the generated tone assigned to said symbol.

A Wrist-worn Multi-sectioned Data Entry Unit

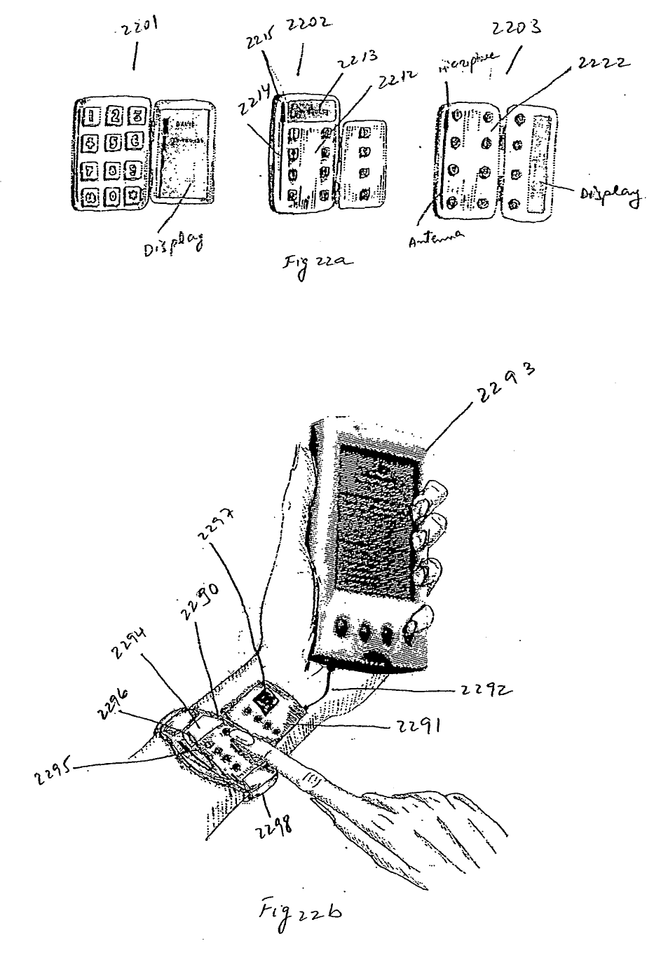

FIG. 22a shows as example, different embodiments of a data entry units 2201-2203 of this invention as described before. To reduce the size of said data entry unit a multi-sectioned data entry unit 2202-2203 which may have a multi-sectioned keypad 2212-2222 as described before, may be provided said multi-sectioned data entry unit may have some or all of the features of this inventions. It may also have an integrated data entry system described in this application. As example, the data entry unit 2202 comprises a display 2213 an antenna 2214 (may be extendable), a microphone 2215 (may be extendable), a mouse integrated in the beck of said data entry unit (not shown).

An embodiment of a data entry unit of this invention may be carried on a wrist. It may be integrated within a wrist worn device such as a watch or within a bracelet such as a wristwatch band. Said data entry unit may have some or all of the features of the integrated data entry unit of this invention. This will permit to have a small data entry unit attached to a user's wrist. Said wrist-worn data entry unit may be used as a data entry unit of any electronic device. By connecting his wrist-worn data entry unit to a desired electronic device, a user for example, may open his apartment door, interact with a TV, interact with a computer, dial a telephone number, etc.. A same data entry unit may be used for operating different electronic devices. For this purpose, an access code may be assigned to each electronic device. By entering (for example, through said data entry unit) the access code of a desired electronic device a connection between said data entry unit and said electronic device may be established.

FIG. 22b shows an example of a wrist-worn data entry unit 2290 (e.g. multi-sectioned data entry unit having a multi-sectioned keypad 2291) of this invention (in open position) connected (wirelessly or through wires 2292) to a hand-held device such as a PDA 2293. Said multi-sectioned data entry unit 2290 may also comprise additional features such as some or all of the features described in this application. In this example, there are provided a display unit 2294 an antenna 2295, a microphone 2296 and a mouse 2297.

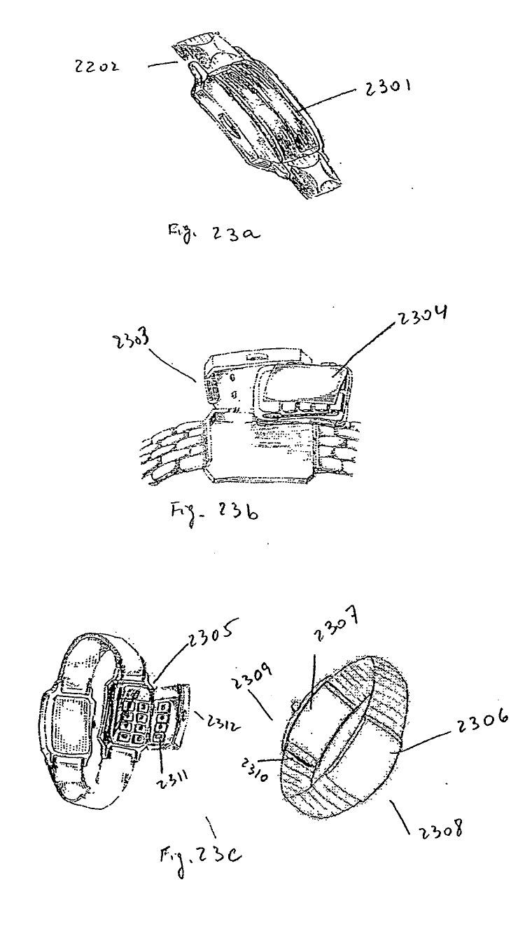

It is understood that said multi-sectioned keypad may be detached from the wrist worn device/bracelet 2298. For this purpose different detachment/attachment known to people skill in the art may be provided. For example, as shown in FIG. 23a, a housing 2301 for containing said data entry device may be provided within a bracelet 2202. FIG. 23b shows said housing 2303 in open position. A detachable data entry unit 2304 may be provided within said housing 2301. FIG. 23c shows said housing in open position 2305 and in close position 2306. In open position (e.g. when using said data entry unit), part of the elements 2311 (e.g. part of the keys and/or display, etc) of said data entry unit may lye down within the cover 2312 of said housing.

According to one embodiment of the invention, a device such as a wristwatch 2307 may be provided in the opposite side on the wrist within the same bracelet. For example, there may be provided a wristwatch band having a housing to contain a data entry unit. Said wristwatch band may be attached to any wrist device such as a wristwatch, a wrist camera, etc. The housing of the data entry device may be located on one side 2308 of a wearer's wrist and the housing of said other wrist device may be located on the opposite side 2309 of said wearer's wrist. To attach said wristband to a device such as a wristwatch the traditional wristwatch band attachment means 2310 (e.g. bars) may be provided.

The above mentioned wristband housing may also be used to contain any other wrist device for example, instead of containing a data entry unit, said wrist housing may be adapted to contain a variety of electronic devices such as a wristphone.

There may be a lot of advantages when using a wrist-worn data entry unit of this invention for example, a user may carry an electronic device in for example, his pocket, and having a display unit (may be flexible) of said electronic device in his hand. The interaction with said electronic device may be provided through said wrist-worn data entry unit. In another example, the wrist-worn data entry unit of this invention may be used to operate an electronic news display (a PCT application regarding an electronic news display has been filed on Oct. 27^{th}, 2000 by the inventor).

Extendable Display Unit

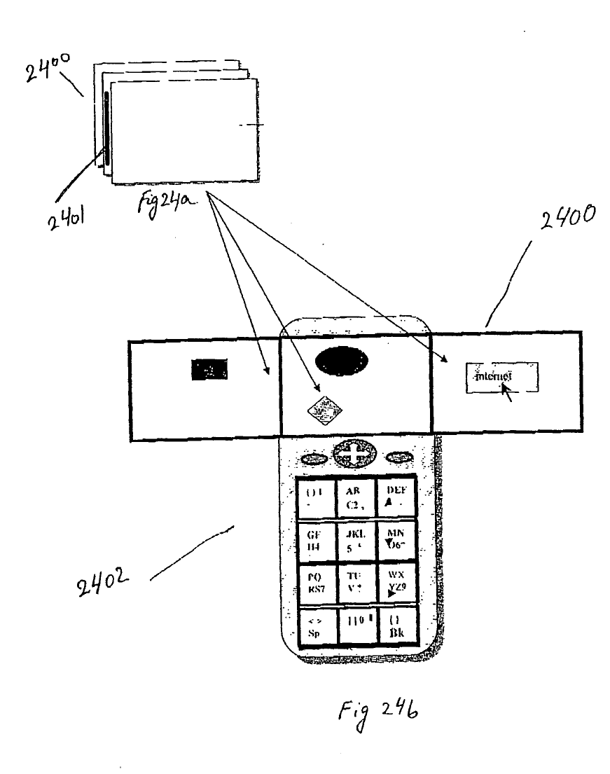

According to one embodiment of the invention an extendable display unit may be provided within an electronic device such as data entry unit of the invention or within a mobile phone. FIG. 24a shows an extendable display unit 2400 in closed position. This display unit may be made of rigid and/or semi rigid materials and may be folded or unfolded for example by corresponding hinges 2401, or being telescopically extended or retracted, or having means to permit it being expanded and being retracted by any method.

FIG. 24b shows a mobile computing device 2402 such as a mobile phone having said extendable display 2400 of this invention, in open position, When open, said extended display unit may have the width of an A4 standard paper permitting the user to see and work on a real width size of a document while, for example, said user in writing a letter with a word processing program or browsing a web page.

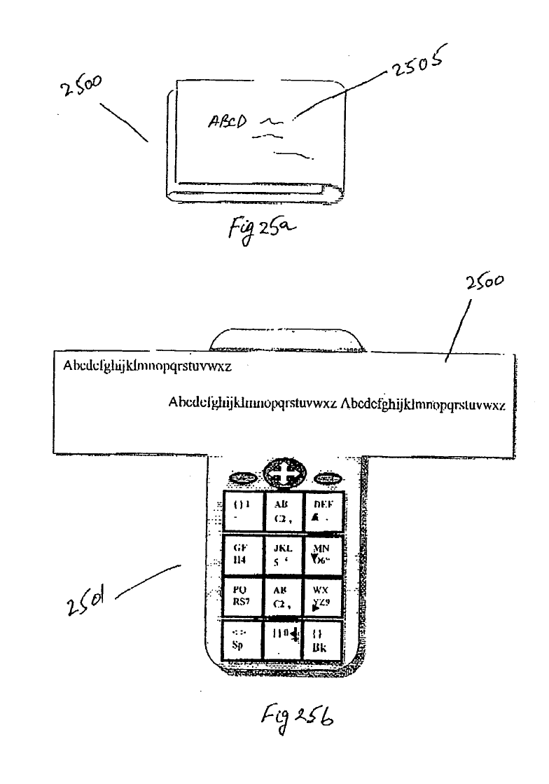

The display unit of the invention may also be made from flexible materials. FIG. 25a shows a flexible display unit 2500 in closed position.

It is understood that the display unit of the invention may also display the information on at least part of it's other (e.g. exterior) side 2505. This is important because in some situations a user may desire to use the display unit without expanding it.

FIG. 25b shows an electronic device 2501 having a flexible display unit 2500 of the invention, in open position.

By having an electronic device such as the data entry unit of the invention, a mobile phone, a PDA, etc., having at least one of the enhanced features of the invention such as an extendable/non extendable display unit comprising a telecommunication means as described before, a mouse of the invention, an extendable microphone, an extendable camera, a data entry system of the invention, a voice recognition system, or any other feature described in this application, a complete data entry/computing device, which may be held and manipulated by one user's hand, may be provided. This is very important because as is well known that in mobile environment computing/data entry at least one of the user's hand must be free.

Extendable Camera

As described for extendable microphone, an electronic device may also be equipped with an extendable camera. For example, for the data entry system of the invention combining keys presses and lip reading (instead or in addition to voice/speech of the user) an extendable camera may be provided in corresponding electronic device or data entry unit.

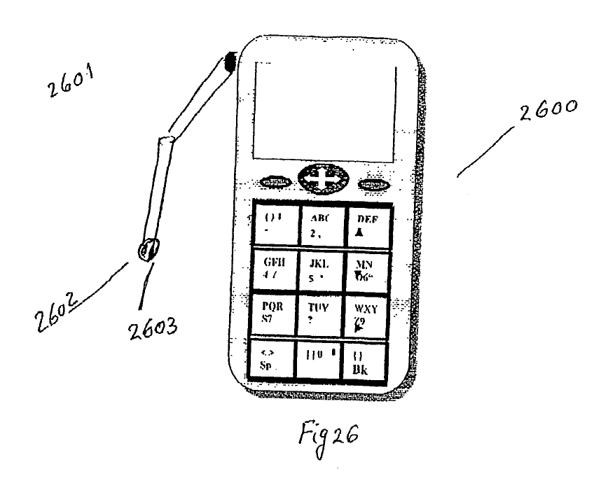

FIG. 26 shows a mobile computing device 2600 equipped with a pivoting section 2601. Said pivoting section may have a camera 2602 and/or a microphone 2603 installed at, for example, its end. By extending the camera towards his mouth, the user may speak to the camera and the camera may transmit images of the user's lips for example, during data entry of the invention using combination of key presses and lips. The user, in the same time may be capable to see the display and the keypad of his phone and eventually use them simultaneously while speaking to the camera. Of course the microphone installed on the extendable section may transmit the user's voice to the voice recognition system of the data entry system.

The extendable section 2601 may contain an antenna, or itself being the antenna of the electronic device.

The data entry method of this invention may also use other data entry means. For example, instead of assigning the symbols to the keys of a keypad, said symbols may be assigned to other objects such as the fingers (or portions of the fingers) of a user. Also instead of (or in addition to) voice/speech input, the system may recognize the data input by reading (recognizing the movements of) the lips of the user in combination with/without key presses. The user may press a key of the keypad and speak a desired letter among the symbols on said key. By recognizing the movements of the user's lips speaking said letter combined with said key press, the system may easily recognize and input the intended letter.

Also as mentioned, example given in method of configuration described in this application were showed as samples. Variety of different configurations and assignment of symbols may be considered depending on data entry unit needed. The principle in this the method of configuration is to define different group of symbols according to different factors such as frequency of use, natural pronunciation, natural non-pronunciation, etc, and assign them accordingly assigning them priority rates. The highest priority rated group (with or without speaking ) is assigned to easiest and most natural key interaction (e.g. a single press). This group also includes the highest ranked non-spoken symbols. Then the second highest priority is assigned to second less easier interaction (e.g. double press) and so on.

Thus, while there have been shown and described and pointed out fundamental novel features of the invention as applied to alternative embodiments thereof, it will be understood that various omissions and substitutions and changes in the form and details of the disclosed invention may be made by those skilled in the art without departing from the spirit of the invention. It is to be understood that the drawings are not necessarily drawn to scale, but that they are merely conceptual in nature. For example, instead of providing a separate pressure system to each key of a keypad, a single pressure sensitive system (e.g. a pressure sensitive pad) may be provided with all of them (e.g. a single large pad above or under the keys). Also a user may interact with a key by other means than his fingers. For example, said user may use a pen to press a key.

What is claimed is:

1. An electronic device having an extendable section containing a microphone for inputting information by voice, wherein;
in open position, said extendable microphone is extended towards a user's mouth.

2. The device according to claim 1, wherein said electronic device has a keypad and wherein said microphone is used in a data entry method combining voice/speech of a user and the key press, and wherein;
in order to select a symbol on a key, the user presses the corresponding key and simultaneously speaks said symbol.

3. The device according to claim 1, wherein said extendable section is multi-sectioned.

4. An electronic device having a data entry unit comprising a keypad and a point and clicking device, wherein;
said keypad and is in located in front side of said electronic device, and;
the pointing device of said data entry unit is located at the backside of said electronic device.

5. The device according to claim 4, wherein said electronic device is held in one user's hand and wherein said user manipulates said data entry unit in a manner; wherein;
said pointing device is manipulated by user's forefinger of said hand, and;
said keypad is simultaneously manipulated by the thumb of said same hand of said user.

6. The device according to claim 4 wherein said electronic device contains an extendable display unit wherein in open position said extended display unit forms an enlarged display unit being positioned approximately perpendicularly to the axis of said electronic device.

7. The device according to claim 4, wherein said electronic device is used as a data entry unit of another electronic device.

8. The device according to claim 7, wherein said data entry unit and said another electronic device comprise wireless communication systems to communicate to with each other.

9. The device according to claim 8, wherein said data entry unit and said another electronic device each comprise a display unit.

10. The device according to claim 9, wherein the display unit of the data entry unit reflects at least a portion of the information displayed on said another electronic device.
